(19) United States
(12) Patent Application Publication
(10) Pub. No.: US 2012/0143755 A1
(43) Pub. Date: Jun. 7, 2012

(54) Collection and Distribution of Customer Service Metric Information

(75) Inventor: C. Jason Burrell, Middleburg, FL (US)

(73) Assignee: BANK OF AMERICA CORPORATION, Charlotte, NC (US)

(21) Appl. No.: 12/958,714

(22) Filed: Dec. 2, 2010

(51) Int. Cl. G06Q 40/00; G06F 17/30

(52) U.S. Cl. 705/43; 705/39; 707/722; 707/E17.014

(57) ABSTRACT

Aspects described herein provide techniques for monitoring, predicting, and providing customer service metrics and wait time information to customers prior to when a customer requests a customer service event that may require a waiting period of otherwise unknown duration. A customer may obtain information regarding a current and/or future predicted wait time for a desired branch of a financial institution. Current wait time information may be provided to help a user determine a branch that is available for immediate service with as short a wait as possible, or that is most time-efficient from the customer's perspective. Wait time information for nearby bank branches may be automatically provided, e.g., when an ATM is out of order. Future and/or predicted wait time information may be provided (e.g., via the Internet) so the customer can plan a convenient time in the future to visit a branch of the financial institution.

### FIELD OF THE INVENTION

The invention relates generally to automated systems for monitoring and providing customer service information. More specifically, the invention provides ways of monitoring, predicting, and providing customer service metrics and wait time information to customers prior to when a customer requests a customer service event that may require a waiting period of otherwise unknown duration.

### BACKGROUND OF THE INVENTION

The most common form of interaction between a financial institution and one of its customers is a transaction using a computing device of some sort, e.g., an automated teller machine (ATM), smartphone, or other computer. Only when an ATM is out of service, or when a customer needs a transaction not offered by an automated device or computer, does the customer typically visit a branch of the financial institution. For example, a visit to a branch might be required to sign a signature card, apply for a loan, obtain a cashier's check, obtain traveler's checks, or access a safe-deposit box. However, prior to physically traveling to a branch of a financial institution, a customer has no way of knowing how long a wait time might be once the customer actually gets to the financial institution.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

To overcome limitations in the prior art described above, and to overcome other limitations that will be apparent upon reading and understanding the present specification, the present invention is directed to methods and systems that provide wait time information for one or more branch locations of a financial institution. According to a first aspect, the method or system receives user input to conduct an automated financial institution transaction via a data processing device (e.g., an ATM, cash vendor, or the like). Upon determining the data processing device to be in a first state, the automated financial institution transaction is completed based on the user input. Upon determining the data processing device to be in a second state (e.g., out of order, out of cash), the data processing device determines that it cannot perform the automated financial institution transaction. As a result, the data processing device identifies a location associated with the data processing device, and queries a database for a wait time associated with one or more branch locations of a financial institution based on the location associated with the data processing device. The one or more wait times are then displayed on a display screen for a user to review.

According to some aspects, wait time information may be provided for N branch locations within a range R of the location associated with the data processing device. Icons may be used to represent wait time lengths, e.g., a first green icon may be representative of a short wait time, a second yellow icon may be representative of a medium wait time, and a third red icon may be representative of a long wait time.

The wait time information may include a current wait time, as well as one or more future predicted wait times. The future predicted wait times may be based on historically collected data or other historically collected wait time information, and may be presented for a future time selected by a user or specified by a server.

According to another aspect, a web server may send first data to a user device for display, where the first data includes a branch finder tool. The server receives user input specifying a location as input to the branch finder tool, and the server queries a branch location database for one or more branch locations based on the input location. The server sends second data to the user device for display, where the second data includes first and second wait time information for each of the one or more branch locations. The first wait time information includes a current wait time at the corresponding branch location, and the second wait time information comprises a future predicted wait time at the corresponding branch location. The future predicted wait time may include multiple predictions based on discrete future time periods, and the predicted future wait times may be based on user input specifying a future time for which a wait time is desired.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a system architecture that may be used to implement one or more illustrative features described herein.

FIG. 2 shows a flow chart of an illustrative method for displaying wait time information.

FIGS. 3-5 show illustrative screenshots according to aspects described herein.

FIG. 6 illustrates a branch locator web page.

FIG. 7 illustrates a branch information web page displaying wait time information according to an illustrative aspect described herein.

FIG. 8 is a flowchart of a method for displaying wait time information according to one or more illustrative aspects.

FIG. 9 is a flowchart of a method for providing wait time alerts according to one or more illustrative aspects.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention. The invention is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As used throughout this description, the term “financial institution” and “bank” are used interchangeably, as are “financial institution representative” and “bank teller” or just “teller.” Aspects described herein are applicable to any institution or organization that services a large customer base such that customers might be required to wait in a line or queue in order to obtain face-to-face customer service of any kind. The examples described herein with respect to a bank or financial institution are illustrative in nature only.

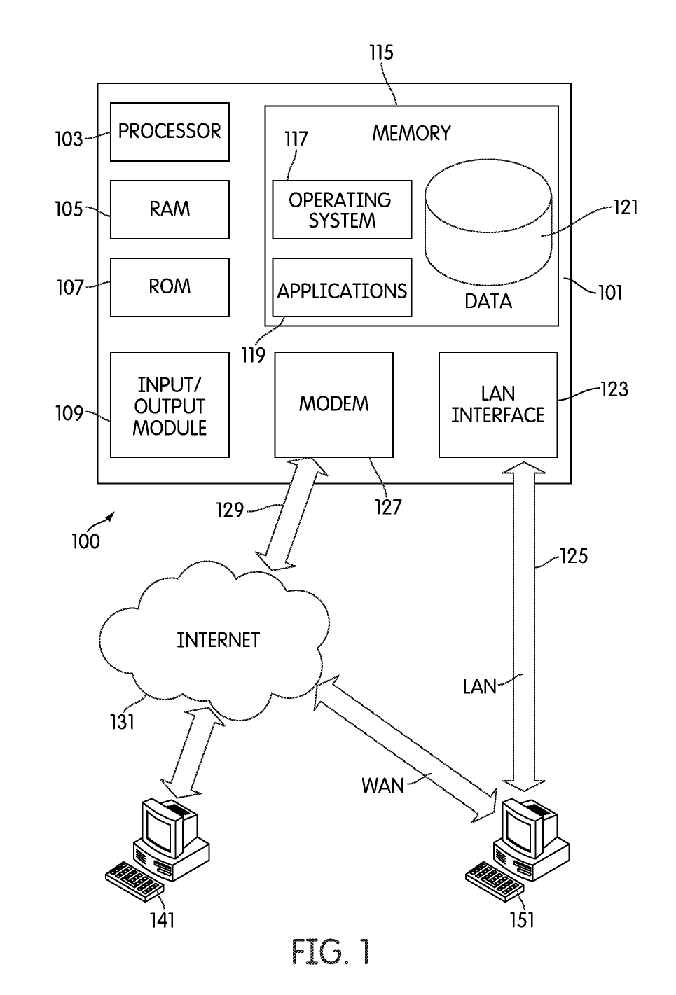

FIG. 1 illustrates a block diagram of a computing device 101 (e.g., a computer server, etc.) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by server 101, such as operating system 117, application programs 119, and associated database 121. Alternatively, some or all of server 101 computer executable instructions may be embodied in hardware or firmware (not shown).

Server 101 may operate in a networked environment supporting connections to one or more remote computers, such as terminals 141 and 151. Terminals 141 and 151 may be personal computers or servers that include many or all of the elements described above relative to the server 101. The network connections depicted in FIG. 1 include a local area network (LAN) 125 and a wide area network (WAN) 129, but may also include other wired or wireless networks. When used in a LAN networking environment, the computer 101 may be connected to LAN 125 through a network interface or adapter 123. When used in a WAN networking environment, the server 101 may include a modem 127 or other wired or wireless network interface for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various financial institutions, such as banks, etc., to identify various customer service metrics and provide those metrics to customers. Using one or more features described herein, a customer may obtain information regarding a current and/or future wait time for a desired branch of a financial institution, e.g., for a local or proximately located branch of the financial institution. Current wait time information may be provided when a user is trying to determine a branch that is available for immediate service with as short a wait as possible, or that is most time-efficient from the customer's perspective (e.g., considering a trade-off of distance to the branch versus expected wait time). Future and/or predicted wait time information may be provided so the customer can plan a convenient time in the future to visit a branch of the financial institution, and thereby conclude his or her business as expeditiously as possible at a time that is convenient to the customer.

Using one or more aspects described herein, a financial institution may collect customer wait times at various banking center locations and provide a customer the wait time forecast for a specified time period. The wait time information may be provided via ATM, mobile device or smartphone, and/or online via a web site or other network channel. Because financial institutions typically offer multiple branch locations convenient to any given customer, the customer can choose a conveniently located branch that has the shortest expected wait time. Customers are given control in terms of selecting the banking center which is currently offering the shortest wait time, thereby maximizing the customers' use of time. As a result, customers typically choose the branch or banking center that offers the shortest wait time, and that is also physically convenient to the customer. When large groups of customers utilize the advance wait time information described herein, a resulting effect is normalization of banking center traffic by predicatively encouraging customers to visit branches with shorter waiting periods, or to visit a desired branch at a non-peak time. As data is collected over time, the systems described herein may also generate and present future forecast wait time information based on historical data.

In general, there are two process phases described herein: data collection and data distribution. Data collection includes any means, method, or procedure by which a wait time is computed, determined, or predicted. Data distribution includes any means, method, or procedure by which wait time information is provided to a customer. Data collection and data distribution will each be described in turn.

Data Collection.

Wait times have at least two classifications: current and projected. Current wait times represent wait times that may be expected if a customer proceeds relatively soon to a branch of a banking institution, e.g., wait times that might be expected upon the customer's arrival at the branch in the next 15-30 minutes. Projected wait times represent historical wait times as future forecasts outside of the current wait times, and provide general guidance to customers while inherently carrying more variable deviation (less accuracy).

The only wait time that can be measured with pinpoint accuracy is a current wait time. That is, anything other than measuring a current actual wait time is an estimate. In addition, a current wait time is typically only valid for some limited amount of time in the future, e.g., no more than thirty minutes. Thus, if a customer wants to know a wait time for a point in time that is more than 30 minutes away, that future wait time might only be able to be generated if there is enough historical data from which the future wait time can be predicted.

There are a variety of ways to measure a current wait time. According to one aspect, each time a bank teller, or other financial institution representative, begins working with a new client, the bank teller counts or estimates the current number of people in line at that point in time. The teller may provide input into a system (e.g., computer 101) regarding an actual number of customers in line, or may provide input indicative of the number of customers in line. For example, a teller may indicate “slow” when 0-2 customers are in line, “steady” when 3-10 customers are in line, and “heavy” when more than ten customers are in line.

Alternatively or additionally, a branch may pass out a timing card to track how long a customer waits in line. A timing card is any small piece of collateral noting the time when a customer gets in line, and, in some arrangements, is designed to hold up to heavy handling and use. When the customer reaches a bank teller or other desired financial institution representative, the teller records the current time along with the time on the card indicating when the customer entered the line to determine the current wait time, e.g., by entering the data in computer 101. According to an illustrative aspect, the timing card may include marketing information, thereby driving interest within a teller line and diluting or distracting a customer during what might otherwise be a negative wait time experience. In some examples, the timing card may include one or more electronic component that provide interactive functionality (e.g., electronic gaming) to maintain a user's interest and help the user pass the time. While not every customer is given a timing card, those who do receive timing cards may also convert others' wait time annoyance into interest around what is being handed out to selective customers. Stated differently, customers who do not receive timing cards might be interested to know what other customers received that they didn't, and in the course of querying the customer who did receive the timing card, time is passed for all the customers in the line.

Each method (teller estimates and timing cards) may also be used alone as a predictor of future wait times. When both methods (teller estimates and timing cards) are used in conjunction with one another, one can more accurately determine the expected wait time based on how many people are in line. That is, based on a combination of known wait time and known number of people in line, one can predict in the future how long a wait time might be, based on the number of people in line, without the use of a timing card. Thus, according to an illustrative aspects, both teller estimates and timing cards might be used for an initial period of time, e.g., 3 or 6 months, and then only teller estimates might be used for any additional period of time, e.g., 3 or 6 months, until a minimum amount of data is acquired that can be used to accurately predict future wait times.

According to another aspect, a teller might collect various pieces of data each time the teller starts and/or finishes working with a new customer (i.e., starts a new session). Data collected at each teller workstation for a given banking center may include Session Start Time, Customer Segment Type (e.g., consumer, small business, mass affluent, etc.), Type of Transaction(s) conducted (e.g., Withdrawal, Deposit, etc.), Transaction Start Time, Transaction End Time, Session End Time, Number of Customers in Line, Banking Center, Teller Workstation, Teller ID, and Date. These data points are merely representative of data that may be collected in a simplified manner to produce analytics around customer wait times. The data list is not meant to be an exhaustive or exclusive list of fields but rather a selection that may be used to produce forecasted wait times. A subset of this information may also be used, as well as additional data fields as needed.

According to yet another aspect, a commercial queue management solution may be used to track how long a customer waits in line, e.g., solutions from Qmatic US in Fletcher, N.C.; Nemo-Q in McKinney, Tex., or using a system such as QMS developed and used by the Virginia Department of Motor Vehicles. The actual system used to collect the data is secondary to the ability to determine a known wait time at a present point in time and/or based on a known number of people presently in line.

Each customer branch visit pattern and timing is irregular and difficult to predict. However, using a combination of historical data mixed in with real-time data, the systems and methods described herein can predict with relative accuracy future wait time metrics, provided enough historical wait time data is available to make statistical analysis reliable. According to one aspect, historical data of at least six months is preferred. According to another aspect, one year of historical data is preferred.

Once a banking center has the minimum amount of historical data, forecasting may also be done based on the historical data, as well as based on current data. Alternatively, current data collection might be limited or stopped, e.g., perform limited updates to current data at regular or irregular intervals, as needed or desired, to ensure that wait time prediction models are current. That is, data collected based on data entry by one or more banking center associates can be implemented in a periodic manner to enrich historically collected data and keep the historical wait time information up to date.

Data Distribution.

As indicated above, after data collection has occurred, data distribution may begin. That is, once the data is in place, when a consumer requests a wait time estimate or forecast, the current or predicted wait time may be provided to the requesting customer. The wait time might be provided in minutes, or in relative time periods (e.g., short, medium, long). “Short” may correspond to a wait time of less than two minutes. “Medium” may correspond to a wait time of 2-5 minutes. “Long” may correspond to a wait time of five or more minutes. Other predetermined intervals may also or alternatively be used. Other time periods may alternatively be used. The wait time information may be provided to the customer via various channels, e.g., via ATM, web, or mobile device, to name a few.

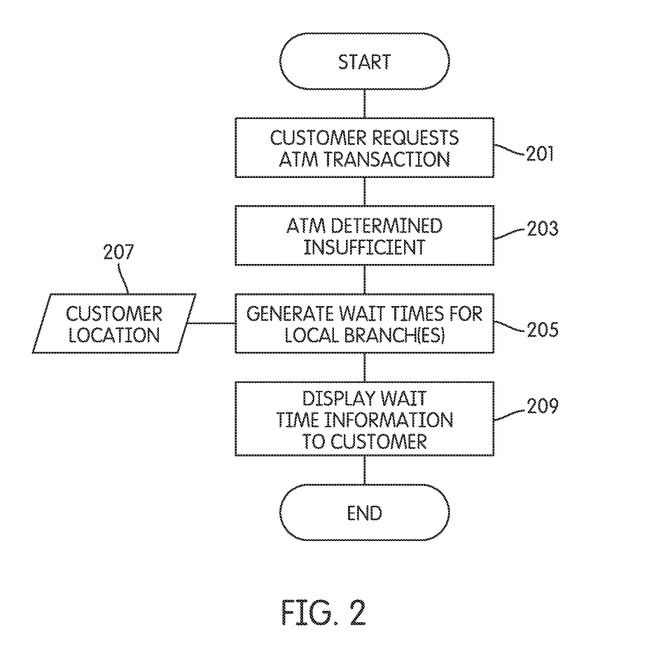

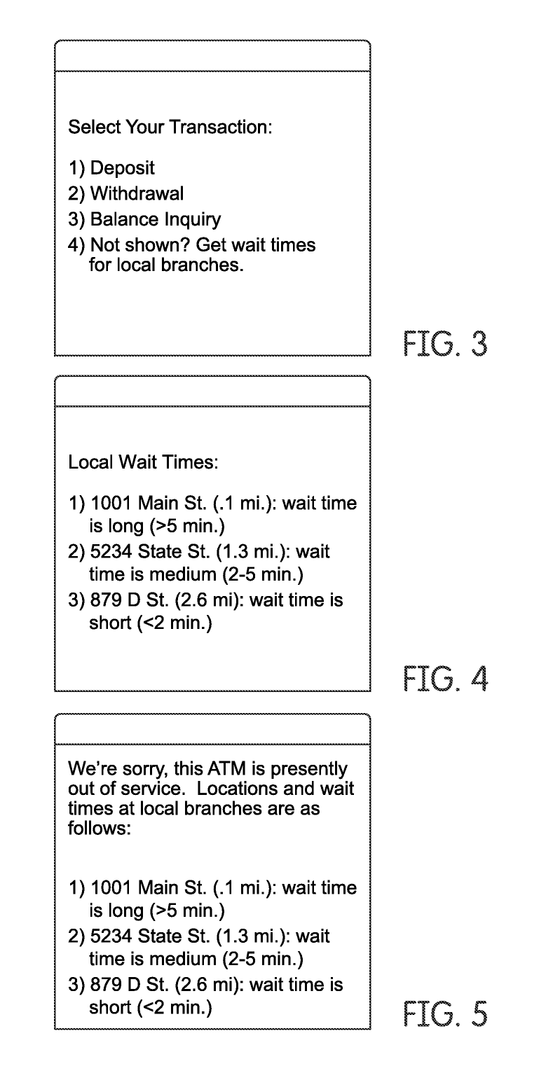

With reference to FIG. 2, an illustrative method for providing wait time information is described. In step 201, a customer approaches an ATM to conduct an automated transaction, e.g., to deposit a check or to make a withdrawal. In step 203, the ATM and/or the customer determines that the ATM will be unable to complete the transaction. For example, the ATM might not perform the type of transaction that the customer desires to conduct, as shown in FIG. 3, or is unable to complete the desired transaction for some other reason (e.g., out of order, out of cash). In such a case, the user can select in step 205 to receive wait time information for one or more local branches, which may be displayed in step 209 as shown in FIG. 4. In generating local wait time information, the customer's location 207 may be used as input. The customer's location may be based on the location of the ATM, or may be based on user input, e.g., a desired city or zip code in which a convenient branch to the user would be located.

Based on the information shown in FIG. 4, the user can decide whether to proceed to the closest branch, which in this example has a long wait time (e.g., due to the ATM being out of service or not able to perform a commonly desired transaction at that time, so many customers are going to the closest branch), or to a branch that is slightly farther away that has a shorter wait time. If the ATM is out of service, the ATM might display a default message with wait time information, as shown in FIG. 5.

In variations of the method shown in FIG. 2, the customer may request data via a mobile device or smartphone, as opposed to requesting data via an ATM. In such a situation, the customer's location may be based on user input (e.g., a desired address, city, zip code, etc.), or based on a location of the smartphone, e.g., as determined by GPS, triangulation, wi-fi hotspot location, or based on any other location-determination system or mechanism in use on the smartphone, mobile device, or data network to which it is connected.

The banking center(s) selected for display to the user with associated wait times may be chosen based on being one of N centers located less than a predetermined range R from the user. For example, if N=3 and R=10, then up to the three closest banking centers within 10 miles are displayed with wait times. N and/or R may be specified by the system or by the user. If less than N banking centers are located within R distance, then less than N banking centers may be displayed, or the system might automatically expand R until N banking centers are identified and displayed.

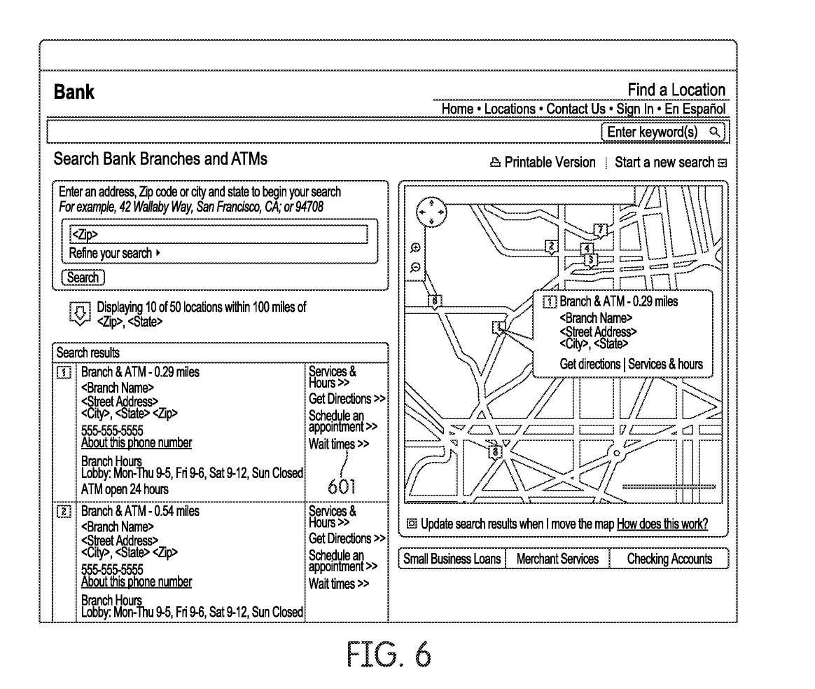

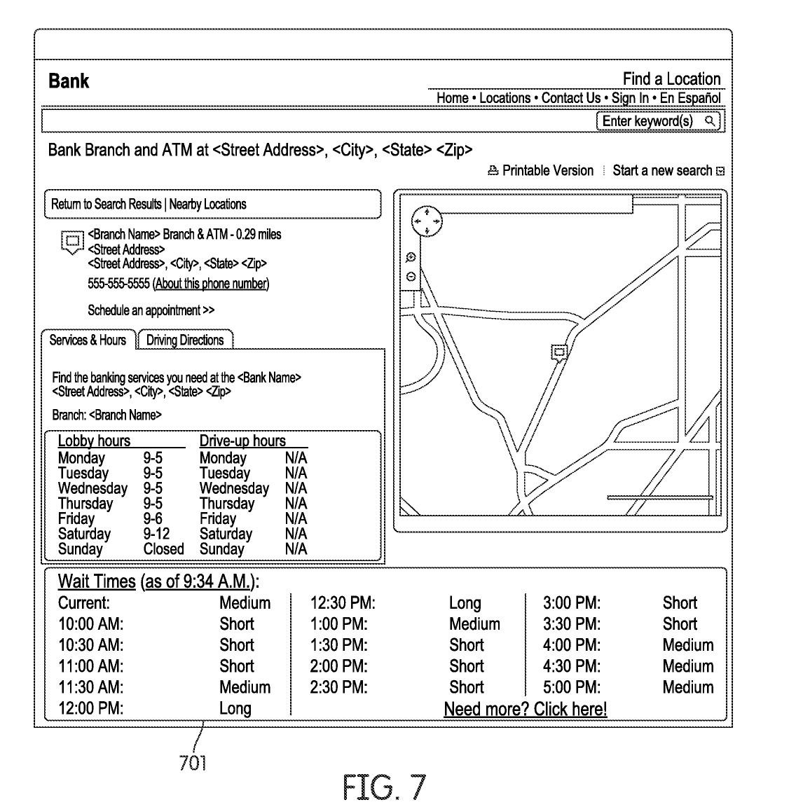

According to another aspect, with reference to FIG. 6 and FIG. 7, a customer might request future wait time information, as opposed to current wait time information. For example, a customer may be planning her schedule for the day, and wants to determine the most efficient time to visit her bank. The customer may browse to the financial institution web site and select a “branch locator” option to identify local branches, as shown in FIG. 6. Any branch finder tool may be used, and the shown “branch locator” is just an illustrative sample. Upon selecting link 601 associated with a desired branch, the web site may display wait time information 701 as shown in FIG. 7, including current as well as predicted wait time information.

Similar information as shown in FIGS. 6 and 7 may be provided via a mobile application or web site designed or tailored for a mobile device such as a smartphone or the like. Visual indicators (not shown) may be used to represent expected wait times, e.g., a green icon may be used to represent a short wait time, a yellow icon may be used to represent a medium wait time, and a red icon may be used to represent a long wait time. Customers may select a banking center as shown in FIG. 6, and subsequently drill down to obtain more details such as current and projected wait times as shown in FIG. 7. A user can thus decide which banking center to visit and selecting when to visit based on current and predicted wait times. The customer can determine when and where to conduct her banking center tasks, based on the wait time and service information provided via the web site or mobile device, with branch information sortable by wait time or by distance from desired/current location.

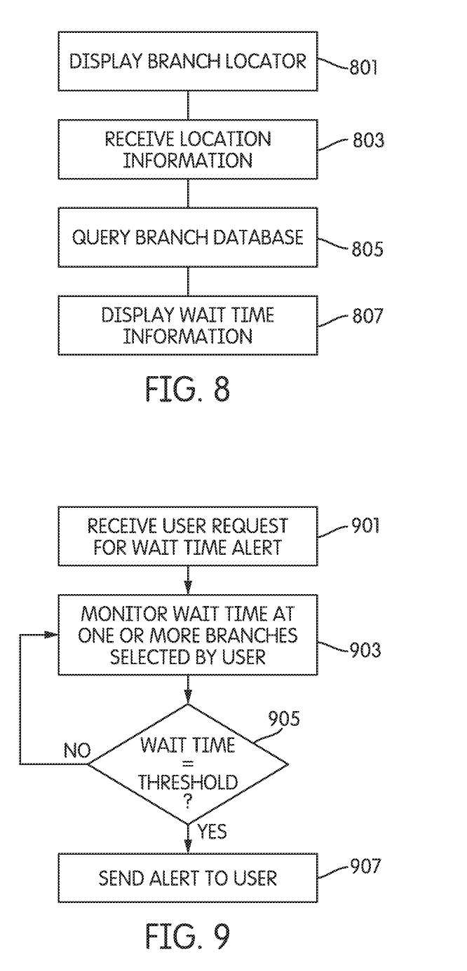

FIG. 8 shows a flowchart for an illustrative method based on the web pages illustrated in FIG. 6 and FIG. 7. In step 801 a web server or other data server (e.g., server 101) sends a first web page or other user interface to a user through which the user can find a local branch of the financial institution. In step 803 the server receives user input identifying a location for which branch location information is desired. In step 805 the server queries a branch location database (e.g., database 121) for one or more branch locations and associated wait time information based on the input location. In step 807 the server sends wait time information to the user device for display. The wait time information may include current wait time information and/or future predicted wait time information. The times for which the future predicted wait time information is provided may be based on predetermined intervals selected by the server, or may be based on one or more specific date and times provides by the user.

Using one or more aspects described above, customers have the capability to determine when and where to conduct their banking center tasks. Depending on the customer's needs and current operating times—customers can either plan the next day or hour in terms of their banking center visit. Customers can select a banking center location and be presented with current and projected wait time details for specified banking centers.

According to an aspect, the system may add a “trend” modifier or indicator to indicate to the user when the current wait time differs from a predicted wait time. Stated differently, the trend indicator may be displayed when the current wait time is at odds with the wait time that otherwise would have been predicted for the current time. For example, at 12:15 PM on Monday the current wait time might be low for a given bank branch. However, based on historical models and data, the system might otherwise predict that the wait time during lunch hour on a Monday would be high. In such a scenario, the system might display the current wait time (i.e., low) but also include the trend indicator to indicate that the historical trend for the current wait time is high. In this manner, a user is informed that, even though the current wait time is low, the user might expect that the wait time can change rapidly, and the wait time might even be medium or high by the time the user reaches the bank branch. The trend indicator may be associated with a weight or a confidence factor so that the user can determine how much the current wait time differs from the trend, or so that the user can determine how accurate the historical trend may be.

According to another feature, a user may request that the system send the user an alert when a wait time reaches a user-specified level. That is, the user might determine that current wait times are too long, but the user's schedule is flexible and the user can delay going to the branch until the wait time is shorter. Instead of relying on future predicted wait times, as discussed above, the user might request that the system send the user a message (e.g., email, SMS, push message via iPhone app, etc.) when the current wait time reaches the low threshold or level. The user may also specify one or more branches that are convenient to the user, and the system will send the alert when the wait time at any of the specified branches is low. The user can then proceed to the corresponding bank branch to conduct his or her business with minimal waiting.

FIG. 9 illustrates a method of sending customized alerts to a user based on current wait time. In step 901 the system receives user input identifying one or more branches for which a wait time alert is desired. The user may also specify a communication channel through which the alert should be sent, e.g., automated phone call, email, SMS or text message, push notification via an iPhone application of the financial institution, etc. The user may optionally also identify the threshold wait time for which an alert should be sent. If the user provides no input, the default threshold may be low. That is, unless the user requests otherwise, the system will send an alert when the wait time is low (as opposed to medium or high or some other level).

In step 903 the system begins monitoring the current wait times at the selected one or more branches. The system might monitor each branch periodically, in intervals, cyclically, or in any other manner or time. In step 905 the system compares the monitored wait time to the threshold wait time for each branch being monitored. When the current wait time at a monitored branch meets the threshold, then in step 907 the system sends an alert to the user indicating the current wait time at the corresponding branch is low (or whatever other threshold was used).

According to another aspect, the system might provide wait time information via SMS or text message. For example, using an automated SMS agent or autoresponder, the financial institution may provide automated wait time information when a text message is sent to a SMS number associated with the financial institution. For example, a user may query wait times based on the user's current location, or based on a location provided by the user (e.g., a zip code). A user might text a special code, e.g., “wait 20009”, to the SMS autoresponder to obtain wait time information for bank branch(es) in or around zip code 20009. The SMS autoresponder might reply “Adams Morgan, 1835 Columbia Rd., NW, Wait time: Medium” to provide the current wait time shown in FIG. 7. The wait time information provided by the autoresponder may be obtained from the database 121.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a processor; and
a memory for storing computer readable instructions that, when executed by said processor, cause the apparatus to perform:
receiving user input to conduct an automated financial institution transaction via the apparatus;
when the apparatus is in a first state, completing the automated financial institution transaction based on user input;
when the apparatus is in a second state, determining that the apparatus cannot perform the automated financial institution transaction;
identifying a location associated with the apparatus;
querying a database for a wait time associated with one or more branch locations of a financial institution based on the location associated with the apparatus; and
displaying the one or more wait times on a display screen.

2. The apparatus of claim 1, wherein the apparatus comprises an automated teller machine (ATM).

3. The apparatus of claim 1, wherein querying comprises querying the database for a wait time associated with N branch locations within a range R of the location associated with the apparatus, where N and R are predefined.

4. The apparatus of claim 1, wherein displaying the wait times comprises displaying a first icon representative of a short wait time, a second icon representative of a medium wait time, and a third icon representative of a long wait time.

5. The apparatus of claim 1, wherein the wait time comprises a current wait time and one or more predicted future wait times.

6. The apparatus of claim 5, wherein the one or more predicted future wait times are based on user input specifying a future time for which a wait time is desired.

7. The apparatus of claim 1, wherein the second state comprises one of an out-of-order state and an out-of-cash state.

8. A method comprising:
receiving user input to conduct an automated financial institution transaction via a data processing device;
upon determining the data processing device to be in a first state, completing the automated financial institution transaction based on user input;
upon determining the data processing device to be in a second state, determining that the data processing device cannot perform the automated financial institution transaction;
identifying a location associated with the data processing device;
querying a database for a wait time associated with one or more branch locations of a financial institution based on the location associated with the data processing device; and
displaying the one or more wait times on a display screen.

9. The method of claim 8, wherein the data processing device comprises an automated teller machine (ATM).

10. The method of claim 8, wherein querying comprises querying the database for a wait time associated with N branch locations within a range R of the location associated with the data processing device, where N and R are predefined.

11. The method of claim 8, wherein displaying the wait times comprises displaying a first icon representative of a short wait time, a second icon representative of a medium wait time, and a third icon representative of a long wait time.

12. The method of claim 8, wherein the wait time comprises a current wait time and one or more predicted future wait times.

13. The method of claim 12, wherein the one or more predicted future wait times are based on user input specifying a future time for which a wait time is desired.

14. The method of claim 8, wherein the second state comprises one or an out-of-order state and an out-of-cash state.

15. A tangible computer readable medium storing instructions that, when executed by a processor, cause a data processing system to perform:
sending first data to a user device for display, said first data comprising a branch finder tool;
receiving user input comprising a location as input to the branch finder tool;
querying a branch location database for one or more branch locations based on the input location;
sending second data to the user device for display, said second data comprising first and second wait time information for each of the one or more branch locations, wherein said first wait time information comprises a current wait time at the corresponding branch location, and said second wait time information comprises a future predicted wait time at the corresponding branch location.

16. The computer readable medium of claim 15, wherein querying comprises querying the database for a wait time associated with N branch locations within a range R of the input location, where N and R are predefined.

17. The computer readable medium of claim 15, wherein each wait time is represented by a first icon representative of a short wait time, a second icon representative of a medium wait time, or a third icon representative of a long wait time.

18. The computer readable medium of claim 15, wherein each future predicted wait time comprises multiple predictions based on discrete future time periods.

19. The computer readable medium of claim 18, wherein the one or more predicted future wait times are based on user input specifying a future time for which a wait time is desired.

20. The computer readable medium of claim 15, wherein second data further comprises a trend indicator indicating when the actual current wait time is different from a predicted value of the current wait time.

21-23. (canceled)
